(19) United States
(12) Patent Application Publication
(10) Pub. No.: US 2015/0213939 A1
(43) Pub. Date: Jul. 30, 2015

(54) STRUCTURE OF ETHERNET SMD (SURFACE MOUNT DEVICE) TYPE SIGNAL TRANSFORMER CONNECTOR

(71) Applicant: KINNEXA, INC., Taipei City (TW)

(72) Inventor: KUAN-HSIUNG WEI, Taipei City (TW)

(73) Assignee: KINNEXA, INC., Taipei City (TW)

(21) Appl. No.: 14/165,490

(22) Filed: Jan. 27, 2014

(51) Int. Cl. H01F 27/06

(52) U.S. Cl. CPC H01F 27/06; H01F 2027/065

(57) ABSTRACT

A structure of an Ethernet SMD type signal transformer connector includes a substrate, at least one first SMD signal transformer, and at least one second SMD common-mode inductor. The substrate has a surface on which a plurality of first conductive wires and second conductive wires are formed. The first SMD signal transformer includes a first SMD-first contact section, a first SMD-second contact section, a first SMD-third contact section, and a first SMD-fourth contact section formed in each end thereof. The second SMD common-mode inductor is connected, via the first conductive wires, to the first SMD-first contact section and the first SMD-fourth contact section. The first SMD-second contact section and the first SMD-third contact section are electrically connected by the second conductive wires. With the above-described arrangement, the overall consumption of material is reduced and the manufacturing process simplified so as to achieve the purposes of saving material and simplifying manufacture.

### TECHNICAL FIELD OF THE INVENTION

The present invention generally relates to an improved structure of an Ethernet connector, and more particularly to a structure of an Ethernet SMD (Surface Mount Device) type signal transformer connector.

### DESCRIPTION OF THE PRIOR ART

Ethernet connectors that are manufactured by different manufacturers having different levels of manufacturing skills may show differences between all related products, but are still in compliance with the specifications and requirements if related communication protocol, such as IEEE (Institute of Electrical and Electronic Engineers) and EMI (Electromagnetic Interference).

To improve performance and to provide better effect, all the manufacturers have devoted themselves to the study and research in respect of the improvement of the Ethernet connectors and attempts have been made to combine all sorts of electronic components, while carefully following the specifications of the communication protocols, for the purposes of manufacturing and providing products of excellent performances.

The current trend for the electronic products is light weight compactness, and thinness. Thus, any proposal that can achieve down sizing of connection ports will be tested. For an Ethernet connector, a signal transformer contained therein has been modified by replacing the commonly used ring-shaped magnetic cores with thinned SMD magnetic cores, in order to greatly reduce the volume of the Ethernet connector.

However, in the manufacture or use of the thinned SMD signal transformers, various different situations must be taken into consideration so that the specification that is used may be varied from case to case. Thus, each time an Ethernet connector of a new specification is manufactured, the specification of originally used thinned SMD signal transformers may be changed. Thus, it is a direction for the manufacturers of the industry to devote themselves to study and research to address the problems and shortcomings of the prior art devices.

### SUMMARY OF THE INVENTION

The primary object of the present invention is that a first SMD signal transformer and a second SMD common-mode inductor are mounted on a substrate and first conductive wires formed on the substrate electrically connect the first SMD signal transformer and the second SMD common-mode inductor to each other. A first SMD-second contact section and a first SMD-third contact section are electrically connected by a second conductive wire formed on the substrate so that manufacturing an Ethernet connector requires no re-manufacture of a signal transformer each time. With the above-described technique, the problem that a conventional Ethernet connector requires re-manufacture a signal transformer of a specific specification can be overcome to thereby achieve advantages of saving material and simplifying manufacture.

To achieve the above object, a structure according to the present invention comprises a substrate, at least one first SMD signal transformer mounted on a surface of the substrate, at least one second SMD common-mode inductor mounted on a surface of the substrate, a plurality of first conductive wires formed on a surfaced of the substrate, and a plurality of second conductive wires formed on a surface of the substrate. The first SMD signal transformer has two ends each forming a first SMD-first contact section, a first SMD-second contact section, a first SMD-third contact section, and a first SMD-fourth contact section. The first conductive wires each have an end respectively connected to the first SMD-first contact section and the first SMD-fourth contact section of the same end of the first SMD signal transformer. The first conductive wires each have an opposite end connected to the second SMD common-mode inductor so that the first SMD signal transformer and the second SMD common-mode inductor are electrically connected. Further, the second conductive wires each have two ends respectively connected to the first SMD-second contact section and the first SMD-third contact section of the same end of the first SMD signal transformer. With such an arrangement, through the first conductive wires and the second conductive wires, the arrangement of an Ethernet connector can be changed through modification of a minimum extent. The entire consumption of material can be reduced and the manufacturing process can be simplified so as to achieve the advantages of saving material and simplifying manufacture.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is a schematic view showing the structure of the preferred embodiment of the present invention.

FIG. 2A is an enlarged view of a portion of the preferred embodiment of the present invention.

FIG. 3 is a block diagram of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

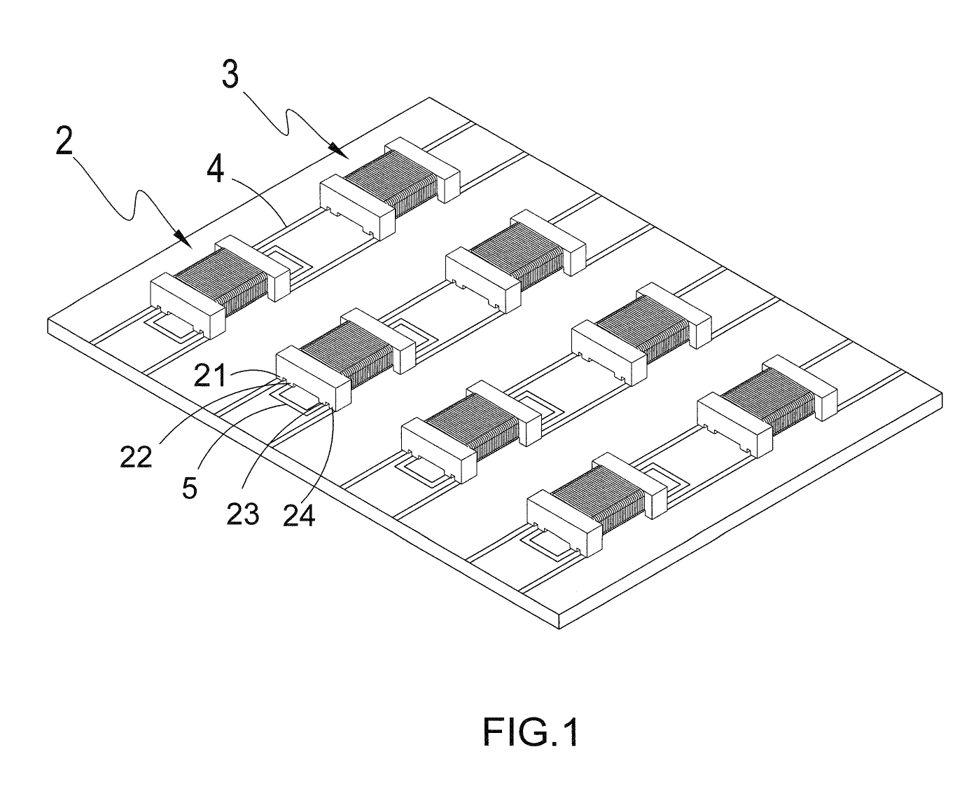

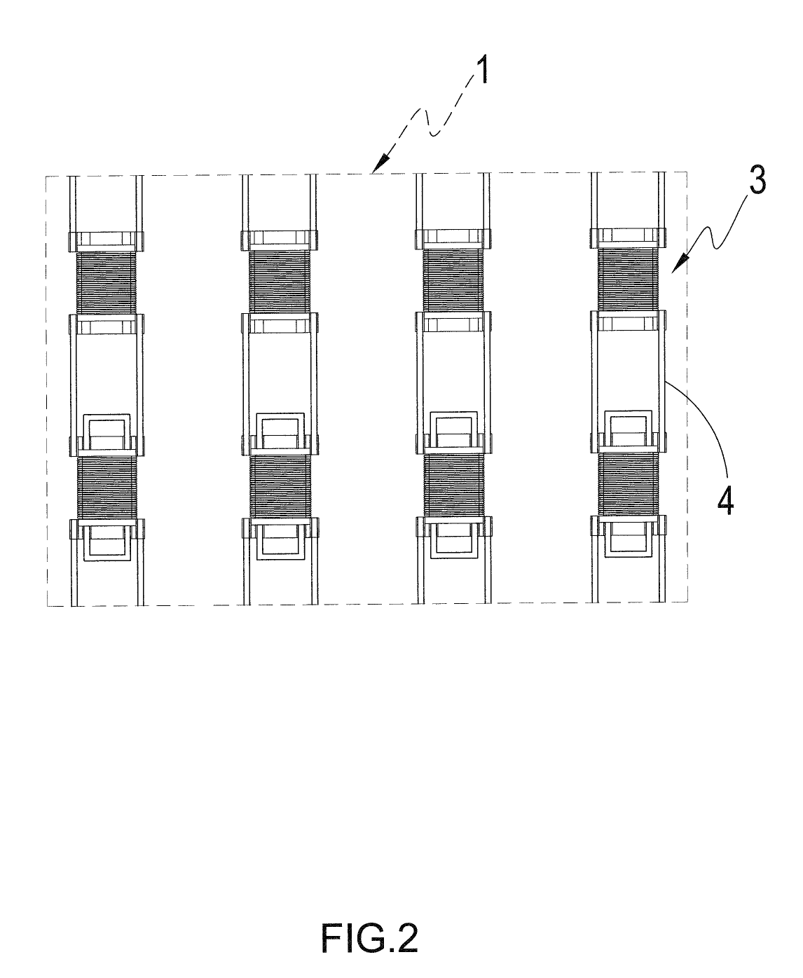

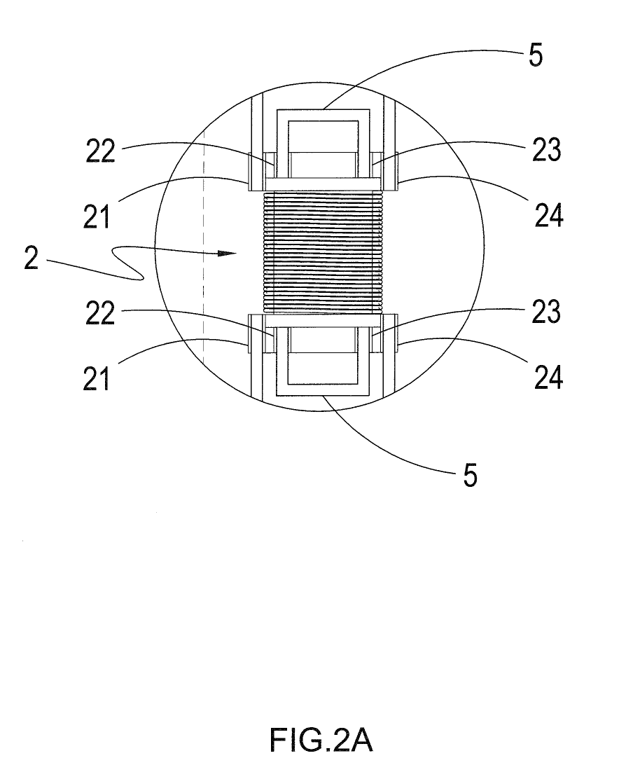

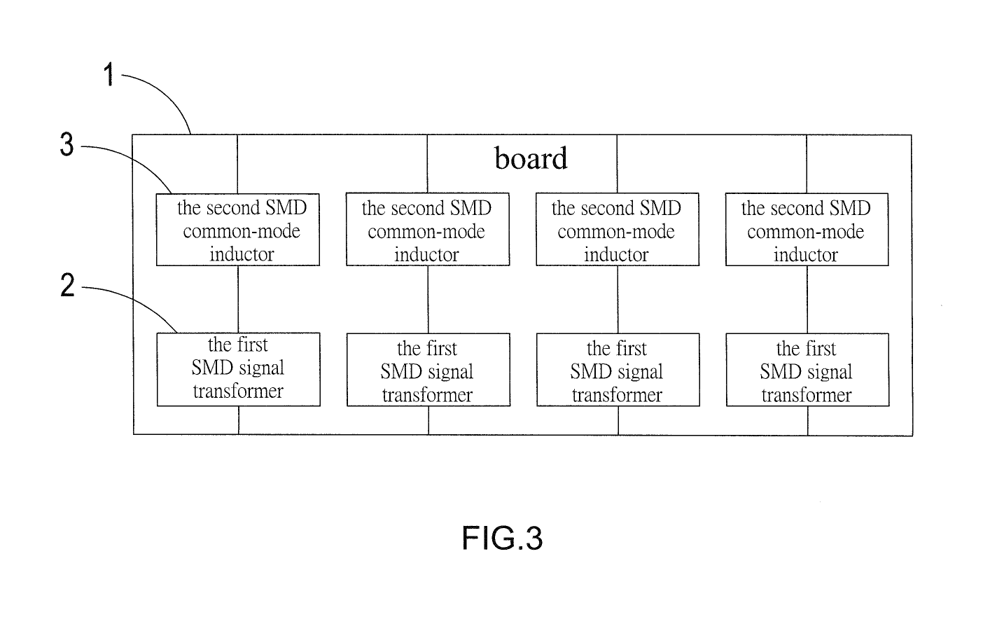

Referring to FIGS. 1-3, which are respectively a perspective view, a schematic view, an enlarged view, and a block diagram of a preferred embodiment of the present invention, the drawings clearly show that the present invention comprises:
a substrate 1;
at least one first SMD signal transformer 2 mounted to a surface of the substrate 1, the first SMD signal transformer 2 having two ends each comprising a first SMD-first contact section 21, a first SMD-second contact section 22, a first SMD-third contact section 23, and a first SMD-fourth contact section 24;
at least one second SMD common-mode inductor 3 mounted to a surface of the substrate 1 and electrically connected to the first SMD signal transformer 2;
a plurality of first conductive wires 4 formed on a surface of the substrate 1, the first conductive wires 4 each having an end connected respectively to the first SMD-first contact section 21 and the first SMD-fourth contact section 24 of the same end of the first SMD signal transformer 2, the first conductive wires 4 each having an opposite end connected to the second SMD common-mode inductor 3; and
a plurality of second conductive wires 5 formed on a surface of the substrate 1, the second conductive wires 5 each having two ends respectively connected to the first SMD-second contact section 22 and the first SMD-third contact section 23 of the same end of the first SMD signal transformer 2.

The first SMD signal transformer 2 and the second SMD common-mode inductor 3 are provided, through surface mounting technology (SMT) on the same surface of the substrate 1. The first conductive wires 4 and the second conductive wires 5 are formed of printed circuits.

The first SMD signal transformer 2 is a pulse signal transformer and the second SMD common-mode inductor 3 is a choke signal transformer.

These drawings clearly show that the substrate 1 is a commonly used printed circuit board (PCB) and the first conductive wires 4 and the second conductive wires 5 are commonly used printed circuits. During the manufacture, the first SMD signal transformer 2 and the second SMD common-mode inductor 3 are mounted, through surface mounting technology (SMT), to the substrate 1. Taking a group of one first SMD signal transformer 2 and one second SMD common-mode inductor 3, two first conductive wires 4 and two second conductive wires 5 are included. The first one of the first conductive wires 4 has an end connected to the first SMD-first contact section 21. The second one of the first conductive wires 4 has an end connected to the first SMD-fourth contact section 24. The two first conductive wires 4 each have an opposite end connected to the second SMD common-mode inductor 3, so as to electrically connect the first SMD signal transformer 2 and the second SMD common-mode inductor 3 to each other. Each of the second conductive wires 5 has two ends respectively connected to first SMD-second contact section 22 and the first SMD-third contact section 23 of one end of the first SMD signal transformer 2. As such, in manufacture or later modification of specification, the design of the Ethernet connector can be varied by changing wire laying of the first conductive wires 4 and the second conductive wires 5 and there is no need to change or re-manufacture the first SMD signal transformer 2, thereby achieving the purposes of saving material and simplifying manufacture.

The key technique that the structure of the connector of the Ethernet SMD signal transformer according to the present invention adopts to improve the known techniques is as follows:

By changing the lay-out of the first conductive wires 4 and the second conductive wires 5 on the substrate 1, modification of the arrangement of an Ethernet connector can be achieved without changing the designs of the first SMD signal transformer 2 and the second SMD common-mode inductor 3, thereby achieving the purposes of saving material and simplifying manufacture.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An Ethernet SMD (Surface Mount Device) type signal transformer connector, comprising:
a substrate;
at least one first SMD signal transformer mounted to a surface of the substrate, the first SMD signal transformer having two ends each comprising a first SMD-first contact section, a first SMD-second contact section, a first SMD-third contact section, and a first SMD-fourth contact section;
at least one second SMD common-mode inductor mounted to a surface of the substrate and electrically connected to the first SMD signal transformer;
a plurality of first conductive wires formed on a surface of the substrate, the first conductive wires each having an end connected respectively to the first SMD-first contact section and the first SMD-fourth contact section of the same end of the first SMD signal transformer, the first conductive wires each having an opposite end connected to the second SMD common-mode inductor; and
a plurality of second conductive wires formed on a surface of the substrate, the second conductive wires each having two ends respectively connected to the first SMD-second contact section and the first SMD-third contact section of the same end of the first SMD signal transformer.

2. The Ethernet SMD type signal transformer connector according to claim 1, wherein the first SMD signal transformer and the second SMD common-mode inductor are mounted to the same surface of the substrate through surface mounting technology (SMT).

3. The Ethernet SMD type signal transformer connector according to claim 1, wherein the first conductive wires and the second conductive wires are formed of printed circuits.

4. The Ethernet SMD type signal transformer connector according to claim 1, wherein the first SMD signal transformer is a pulse signal transformer.

5. The Ethernet SMD type signal transformer connector according to claim 1, wherein the second SMD common-mode inductor is a common mode choke.
